(19) United States
(12) Patent Application Publication
(10) Pub. No.: US 2007/0121473 A1
(43) Pub. Date: May 31, 2007

(54) Laser scanning microscope with a non-descanned detection and/or observation beam path

(75) Inventors: Ralph Lange, Jena (DE); Ralf Wolleschensky, Apolda (DE); Michael Goelles, Jena (DE)

Correspondence Address: JACOBSON HOLMAN PLLC, 400 SEVENTH STREET N.W., SUITE 600, WASHINGTON, DC, 20004, US

(73) Assignee: CARL ZEISS JENA GMBH, Jena (DE)

(21) Appl. No.: 10/577,657

(22) PCT Filed: Oct. 20, 2004
(86) PCT No.: PCT/EP04/11846

§ 371 Date: May 1, 2006

(30) Foreign Application Priority Data
Oct. 30, 2003 (DE) 103 51 414.7

(51) Int. Cl. G11B 7/135

(52) U.S. Cl. 369/112.16

(57) ABSTRACT

Laser Scanning Microscope with a non-descanned detection and/or observation beam path, wherein a beam splitter is provided for the separation of the illumination and the detection beam paths. In the direction of the detection, at least one optical arrangement is provided for the regular transmission of the detected light, whereby between the beam splitter and the optical system, an additional optical arrangement is provided for reducing the diameter of the bundle of the beam to be imaged.

### CROSS-REFERENCE TO RELATED APPLICATIONS

This is a nationalization of PCT International Application No. PCT/EP2004/011846 with an International Filing Date of Oct. 20, 2004, published in German.

### BACKGROUND OF THE INVENTION

1. Field of the Invention

The present invention relates to a Laser Scanning Microscope employing a non-descanned detection method and to the use of auxiliary optical arrangements to improve the microscopes performance.

2. Description of Related Art

In Laser Scanning Microscopy, the Non-Descanned Detection method (NDD) is frequently employed. This method is especially important, if highly scattering probes are to be examined or large penetration ranges are to be achieved, and only very closely adjacent mirrors with limited light conductivity are available in the LSM scan head for the detection. In that case, the detection of the excitation to be modulated takes place externally in non-descanned manner in the vicinity of an aperture diaphragm.

Usually, the excitation in the UV/VIS range is generated through a two-photon process with pulsed IR radiation. An example of this is disclosed in U.S. Pat. No. 5,034,613. The total emitted fluorescence radiation is then assigned to the excitation in the confocal volume of the focus, and can be detected, possibly after scattering several times in the probe, in the reflected light channel or the transmitted light channel. For that, high light conductivity is necessary in the detection channel.

For this reason, a basic requirement in optimized layouts lies in the effective and probe-near detection of the fluorescence radiation, in order to maximize the effective field of vision as the virtual source of scattered light. The accessibility in these regions is however frequently limited due to the interfaces of the microscope stand itself, as well as due to the supplementary devices used, like pipettes and electrodes. A significant boundary condition is given by the detector itself, which exhibits not only spectral but also positional and angle-dependent sensitivities.

Further, one must assume that the remaining microscope optics that are to be used are set up for a regular beam path, and have a bounded free diameter. In order to prevent trimming of the scattered light at the borders of the subsequent optical system, such as the tube lens or the illumination optics in the reflected light channel, the excitation and the emission must be separated in the reflected light beam path near the objective. In general, “push & click” beam splitters are used by default in the reflector plane of the mirror in the reflected light channel in order to maintain maximum possible flexibility. The boundaries of the subsequent regular layout of the optical system are largely taken for granted hitherto. In particular, it is of advantage if the defined interfaces, such as the TV port, are used for coupling in the detection module. With the position and the size of such an interface, however, most of the main boundary conditions for the transmission of the stray light are fixed.

### BRIEF SUMMARY OF THE INVENTION

The aim of the claimed arrangement lies in modifying the beam path immediately after the separation of the excitation and the detection of the beam path in such a manner that the maximum possible (untrimmed) visual field can be imaged onto the detector, taking into consideration the subsequent optical arrangement in the beam path.

One such advantageous embodiment involves positioning of an additional optical arrangement, preferably comprising a convex lens in the small reflector frame of the reflected light channel mirror. Its dimensions are determined on the basis of a compromise between the maximum deflection of the main beam and the resulting not-too-large diameter of the bundle. In particular, the optimization can take place in such manner that the NDD module can be used at a TV port.

The present invention may be implemented in a Laser Scanning Microscope with a non-descanned detection and/or observation beam path, illumination and detection beam paths and a direction of detection. The Laser Scanning Microscope includes a beam splitter positioned for separation of the illumination and detection beam paths. At least one optical arrangement is positioned in the direction of detection for regular transmission of a detected light. A second optical arrangement is provided between the beam splitter and the optical arrangement for reducing the diameter of a bundle of a beam to be imaged.

### BRIEF DESCRIPTION OF THE DRAWING

FIG. 1, the lone FIGURE is a schematic diagram of a portion of a Laser Scanning Microscope according to the present invention.

### DETAILED DESCRIPTION OF THE INVENTION

In describing preferred embodiments of the present invention illustrated in the drawings, specific terminology is employed for the sake of clarity. However, the invention is not intended to be limited to the specific terminology so selected, and it is to be understood that each specific element includes all technical equivalents that operate in a similar manner to accomplish a similar purpose.

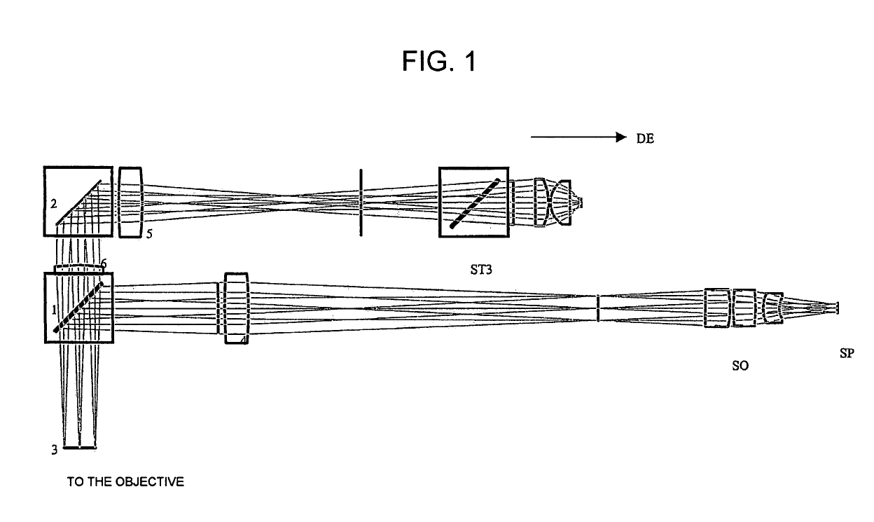

FIG. 1 explains the effect of the arrangement for a beam path. Shown is a part of the beam path in a Laser Scanning Microscope (see, for instance U.S. Pat. No. 6,167,173 which is incorporated by reference herein as if reproduced herein), from a scanner aperture diaphragm SP to a scan objective SO for transmission of the illumination light beam, an illumination tube lens 5 and a beam splitter 1 (main dichroic beam splitter for separating the excitation and the detection beam) in the direction of the objective (only the objective aperture diaphragm 3 is shown here).

A non-descanned detection beam path passes through the beam splitter 1 and a mirror 2 as well as a detection tube lens 4 in the direction of the detection, whereby another beam splitter ST 3 can be provided for masking the illumination beam path. On insertion of a convex lens 6 at the reflector 1 immediately after the reflection, the normally used diameter of the reflector 2 is reduced, thus enabling greater transparency for the scattered light. One can see that, in particular, the normally used diameter before the illumination tube lens 4 is distinctly greater compared to that of detection tube lens 5, which are each at the same distance from the objective, and thus directly illustrates the derived benefit. In the example shown, the aperture at the border area can be increased by about 15%, corresponding to about 30% increase in the brightness.

The convex lens can be inserted with advantage immediately on the reflector at the reflector housing, for instance, at an insertion slot, whereby the available slots for the insertion of the filters can also be used. It is advantageous if the lens is also replaceable or can be plugged in and out.

It can also be arranged in the direction of the detection before the reflector 2 at its reflector housing.

A second lens can also be provided at the mirror 2 or can be integrated in the mirror housing, singly or in combination with a lens at the beam splitter. It can also comprise a tilted mirror in a deflecting element in the form of a convex or a concave mirror.

It is to be understood that the present invention is not limited to the illustrated embodiments described herein. Modifications and variations of the above-described embodiments of the present invention are possible, as appreciated by those skilled in the art in light of the above teachings. It is therefore to be understood that, within the scope of the appended claims and their equivalents, the invention may be practiced otherwise than as specifically described.

1. A Laser Scanning Microscope with a non-descanned detection and/or observation beam path, illumination and detection beam paths and a direction of detection, the Laser Scanning Microscope comprising:
a beam splitter positioned for separation of the illumination and detection beam paths;
at least one optical arrangement in the direction of detection for regular transmission of detected light; and
a second optical arrangement between the beam splitter and the optical arrangement for reducing the diameter of a bundle of a beam to be imaged.

2. The Laser Scanning Microscope according to claim 1, wherein the second optical arrangement is a convex lens.

3. The Laser Scanning Microscope according to claim 1, wherein the second optical arrangement is a diffractive optical element (DOE).

4. The Laser Scanning Microscope according to claim 1, wherein the beam splitter is contained within a housing, the second optical arrangement being mounted immediately at the beam splitter housing in the direction of the detection.

5. The Laser Scanning Microscope according to claim 4, wherein the second optical arrangement is integrated in the housing of the beam splitter.

6. The Laser Scanning Microscope according to claim 1, wherein the second optical arrangement is replaceable or can be plugged in.

7. The Laser Scanning Microscope according to one claim 1 wherein a second lens is provided on another deflecting element or is integrated in the deflecting element, singly or in combination with the second element at the beam splitter.

8. The Laser Scanning Microscope according to claim 1, wherein the second optical arrangement comprises a tilted mirror in an deflecting element in the form of a convex or concave mirror.
